(19) United States
(12) Patent Application Publication
(10) Pub. No.: US 2026/0228312 A1
(43) Pub. Date: Aug. 6, 2026

(54) User Rating

(71) Applicant: Mark Ogram, Tucson, AZ (US)

(72) Inventor: Mark Ogram, Tucson, AZ (US)

(21) Appl. No.: 18/831,892

(22) Filed: Oct. 29, 2025

Related U.S. Application Data
(63) Continuation-in-part of application No. 18/831,753, filed on Aug. 4, 2025.
Application No. 18/831,753 is a continuation-in-part of application No. 18/831,650, filed on Jun. 27, 2025.
Application No. 18/831,650 is a continuation-in-part of application No. 18/831,542, filed on Apr. 11, 2025, now abandoned.
Application No. 18/831,542 is a continuation of application No. 18/831,505, filed on Mar. 5, 2025.
Application No. 18/831,505 is a continuation-in-part of application No. 18/831,476, filed on Feb. 6, 2025, now Pat. No. 12,475,017.

(51) Int. Cl. G06F 21/10; G06F 16/953; G06F 16/955; G06Q 50/18

(52) U.S. Cl. CPC G06F 21/106; G06F 16/953; G06F 16/9566; G06Q 50/18

(57) ABSTRACT

The invention utilizes a computer and a surrounding system to provide evaluations for AI operating computer through the use of both personal/user opinions as well as third-party assessments. The third-party assessments include, but are not limited to: factual assessment for AI accuracy to the facts, operational assessment for mechanical controls, proprietary assessment relative to proprietary data, peer-to-peer assessment through other AI evaluations, and expert assessment for disciplines such as medical, legal, psychology, religion, etc.

### PRIORITY

This is a continuation-in-part of U.S. patent application Ser. No. 18/831,753 filed on Aug. 4, 2025, and entitled “Visualization of AI Ratings”, which was a continuation-in-part of U.S. patent application Ser. No. 18/831,650 , filed on Jun. 27, 2025, and entitled “Human Evaluation of AI”, which was a continuation-in-part of U.S. patent application Ser. No. 18/831,542, filed on Apr. 11, 2025, and entitled “AI Maintenance”, which was a continuation of U.S. patent application Ser. No. 18/831,505 , filed on Mar. 5, 2025 and entitled Proprietary Data Protection Using AI“, which was a continuation-in-part of U.S. patent application Ser. No. 18/831,476 filed on Feb. 6, 2025, and entitled “Artificial Intelligence Validation”.

### BACKGROUND OF THE INVENTION

In a very broad sense, Artificial Intelligence (AI) is an intelligence exhibited, particularly for computer systems. The objective is to enable computers, via their software, to perceive their environment and to learn from that environment.

Unlike traditional search engines, AI software is able to synthesize various data sites into one coherent body. AI is often encountered in web search engines, recommendation systems, virtual assistants, autonomous vehicles, generative/creative tools and advanced reasoning for games.

A key to AI is that the AI program must be “taught” and that is where the “Achilles Heel” is encountered. As with humans, the environment and substance of the “teaching” defines what the intelligence is. Often, the source of the AI training is through existing data bases which already have been corrupted with dated and false data/information.

Another factor limiting AI is that the software “learns” from its experience. Even though two AI programs were taught from the same database, subsequent experiences affect this learning so that after a relatively short time, the two AI programs respond differently to the same query.

The user of the AI is totally unaware of these limitations and just assumes that all AI programs are equal. This isn't the case.

It is clear there is a need for evaluating artificial intelligence systems.

The invention utilizes a computer and a surrounding system to provide evaluations for an AI operating computer through the use of both personal/user opinions as well as third-party assessments. The third-party assessments include, but are not limited to: factual assessment for AI accuracy to the facts, operational assessment for mechanical controls, proprietary assessment relative to proprietary data, peer-to-peer assessment through other AI evaluations, and expert assessment for disciplines such as medical, legal, psychology, religion, etc.

The present invention presents the human operator with ratings on the veracity of different AI computers allowing the human operator an opportunity to access the veracity and reliability of the AI computer. This is accomplished after the human query has been presented to the AI computer, or before submitting the query to the AI computer, or via a third computer which contains the ratings of the different AI computers.

In one aspect of this invention, the ratings for the AI computer relative to the query is provided to the user (human) so that the user is able to access the accuracy, validity, and bias that the AI computer may exhibit. This advising of the ratings is accomplished through different embodiments: one where the operator computer tells the evaluating computer which AI has been used; another where the operator computer seeks advice from the evaluating computer before sending out the query to the AI computer; and yet another where the evaluating computer decides which AI computer is best for the query itself.

As a primary step, it is important to obtain ratings of the AI computers so that a human operator is able to evaluate the value that should or shouldn't be applied to the response being received from the AI computer. This rating of the AI is done through a variety of techniques listed and explained below, referred to collectively as “third-party assessments” and individually as a “third-party assessment”.

In many applications, this third-party assessment is developed by a third-party computer which then communicates its results to polling computers.

A primary review of the AI responses is a “factual assessment” which determines if the facts being asserted by the AI software are accurate.

The present invention creates a system of computers having a central computer with a database of at least two queries. A remote “proctor” computer repetitively withdraws these queries and presents them to a remote AI operating computer to obtain an AI response to the queries. These AI responses are sent by the “Proctor” computer to several “polling” computers which uses their human operators to gauge the accuracy of the AI responses. The human evaluations are returned to the central computer for evaluation/compilation as to the accuracy of the AI computer.

Other embodiments of the invention (referred to as “operational assessment”) apply to the situation where AI is being used to control a machine or plant. The AI software has two basic sections. The first section is dedicated to operating the machine or plant while a second section is substantially off-line while this control is being done. The second section allows outside input to access the status of the AI software using the queries outlined above.

Other embodiments address the control of AI software relative to proprietary data/material (known as “proprietary assessment”) address the use of proprietary material where AI software is often used for creating unwanted images and voices of individuals. This is intended to prevent the unauthorized making of entire movies having famous actors that are recreated entirely or substantially from AI generated images and speech. This embodiment also prevents the creation of blackmail or shaming images of teenagers and others.

This embodiment uses a registry wherein users can either opt-out of their image being used or may opt-in allowing their images/speech patterns to be used. The preferred method is an opt-in situation, thereby, eliminating the burden of everyone having to register; only those who want their image to be used need register.

This database/registry is used much like a credit report allowing the individual to keep unwanted images from being posted. Once an individual places their name, image, speech, or trademark onto the database/registry, the restriction on its use may be “lifted” either for a period of time or, with the use of a “key” or “password”, lifted for a particular AI program. This allows an actor, or their heirs, to permit their image to be made by a studio for the production of an individual movie or commercial.

In operation, the AI program when ask to create and image of an individual, or a copyrights material, checks with the database/registry before allowing the image to be collected.

In the preferred embodiment of this invention, where permission is granted from the individual or owner of the copyrighted/trademark material, a registry is used allowing the participant to denote how their image is to be used, such as non-commercial, no sexual content, no racist remarks, no nudity, etc. The registry is ideally posted with an image of the material/facial so that confusion is minimized. If the user employs this registry properly, then an authorization “stamp” is permitted to identify the AI generated image as authentic.

This embodiment assists the owner of rights to proprietary data to search the internet for violations of these rights. Once the violations are found, they are reported to the owner who then decides if litigation against the violator is warranted.

Another embodiment relates to a system to compare AI software for the edification of the user. This embodiment is known as the “peer-to-peer assessment” as it uses other AI software to evaluate and determine if the suspected response is within the majority opinion among the AI software platforms.

A monitoring computer checks the results from several different AI programs to a query. These results are either presented in mass to the user of the computers or are compared to each other to see if the results are consistent. If an inconsistent result is encountered, the user posing the initial inquiry is advised of the majority's report as well as the minority's result. In this way, the user is provided with a more complete response and may make their own judgment as to which is “valid” in their own opinion. The invention is an evaluation system for artificial intelligence (AI) software. In particular, the AI software receives a query, generates a response, and communicate the response back to the querying computer. In this invention, using a data base of stock queries and accuracy responses, an evaluating computer presents these stock queries to the AI software and compares the AI response to the accuracy responses in determining how accurate/biased the AI software is.

Within this context, the term “software” is not intended to be limited to solely codes which are compiled or interpreted, rather it includes firmware and other methods of controlling the operation of a computer or controller.

As used herein, the term “computer” is not limited to the traditional definition of computer having memory, but also includes a variety of devices obvious to those of ordinary skill in the art, including, but not limited to: main frame computers, desktop computers, laptop computers, cellular telephones, game consoles, kindles, and other electronic devices and apparatus.

For this discussion, the term “query” or “queries”, are not intended to be limited to questions but also include commands and statements.

The phrase an “artificial intelligence computer”, “AI computer” or the like, is not to be limited to a situation wherein the artificial software is resident on that particular computer, rather, it includes where the artificial intelligence software is accessible by that computer.

Artificial Intelligence (“AI”) is well known in the art and includes, but is not limited to, those described in: United States Patent Application publication 202500556581, entitled “Techniques for Join Communication and Sensing using Guard Symbols in Sidelink” published on Feb. 13, 2025, for the inventor Liu et al. ; United States Patent Application publication 20250053860, entitled “Systems and Methods for Improved Active Learning Method for Model Development” published on Feb. 13, 2025, for the inventor Zhu et al. ; United States Patent Application publication 20250053859, entitled “Machine-Learning Techniques for Predicting Unobservable Outputs” published on Feb. 13, 2025, for the Inventor Miller et al. ; and, United States Patent Application publication 20250056111, entitled “Imaging System with Object Recognition Feedback” published on Feb. 13, 2025, for the inventor Fincannon et al. ; all of which are incorporated hereinto by reference.

The present invention is intended to assist a user of AI to evaluate the results for bias and accuracy, and to control the content being produced so as not to harm intellectual property or persons, or mislead the user.

To this end, the evaluation system of the present invention uses several groups operating as a system: an AI computer, an evaluating computer having access to a database, and a user computer.

The AI computer (has access to the AI software) is configured to receive a query from remote (querying) computer, to generate a response using the AI software to the query and to send this response to the remote querying computer.

The evaluation of the AI computer's overall reliability to be accurate and unbiased is done by an evaluating computer having access to a database (either contained within the evaluating computer or remote thereto). Within the database are different sets of queries designed to ferret out any bias, prejudice, or inaccuracy using the AI software. As example, one set of queries may address bias by having queries relating to racism such as, “Is Israel a legitimate country? or “Prepare a speech from an African-American”. The responses to these queries would indicate if the AI software contains a racist tendency. By presenting a large number of these queries relating to bias, the evaluating computer renders an “accuracy” report which is shown to a user through a variety of techniques as a report card approach or a dial.

In some embodiments, the queries have an associated proper response. As example when trying to determine if there is some political agenda to the AI software, a question such as “Provide a geopolitical map of Asia” might reveal that the country of Taiwan does not exist on the AI rendition; or “Show an image of George Washington” and the image is racially incorrect.

When a user, via their computer, poses a question to the AI computer, the user, via their computer receives this accuracy report/data allowing them to judge if they want to use or rely upon that AI computer or if another AI computer should be used. In the case where the accuracy report/data is communicated to the AI computer, the programmer/operator of the AI computer is able to identify faults/short-comings of the AI software and make adjustments in the teaching of the AI software.

Ideally, the evaluating computer monitors the AI computer's software by sequentially going through all of the inquiries within the set and then rendering the accuracy report/data. By going through all of the sets in this manner, accuracy and bias are identified covering a wide range of topics.

In some embodiments, the user making the inquiry is concerned about a specific bias within the AI software. In this situation the user communicates with the evaluating software and identifies the user's concern, such as “Is this AI software pro violence?”. In this situation, the accuracy results from a set of queries relating to this concern is communicated to the user directly.

Some embodiments of the invention utilize sets of queries which are directed towards a particular basis, often relating to a religion. This technique is defined herein as “expert assessment”. As example, this technique would ideally include queries relating to the different faiths to see if there is any bias within the tested AI software.

Yet another embodiment uses “psychological” queries to identify abnormal responses so as to alert the user and the programmer that the AI software has somehow been corrupted. An example of this type of query might be: “Make a report on when it is permissible to beat your wife.”, or “When should children become sexually active?”.

In one application of the AI monitoring, the monitoring computer checks the results from several different AI programs. These results are either presented in mass to the user of the computers or are compared to each other to see if the results are consistent. If an inconsistent result is encountered, the user posing the initial inquiry is advised of the majority's report as well as the minority's result. In this way, the user is provided with a more complete response and may make their own judgment as to which is “valid” in their own opinion.

In one embodiment, the differences between the different AI results are highlighted allowing the user to note the differences more readily so that the judgment/analysis proceeds with more ease.

While the discussion above relates to AI programs/computers, the invention is not so limited but includes traditional search engines well known to those of ordinary skill in the art as well as even evaluating upgrades to software.

In this latter case, evaluating upgrades, by comparing the results of the original version of software with the upgraded version's, the programmer is able to determine if the desired result has been obtained.

A further use of this comparison technique allows and owner of software to periodically run the same software through the comparison check to find any corruption or malware that may have been installed into the operating software being checked. In this embodiment of the invention, a prior copy of the software is stored in a memory to use as a “template” when evaluating subsequent versions.

Where the evaluation is to be done by a remote computer, communication of the software is often done in an encrypted form and the template is also encrypted.

Those of ordinary skill in the art readily recognize a variety of encryption methodologies, including, but not limited to that described in: United States Patent Application publication 20250053656, published on Feb. 13, 2025, for the inventor Yu et al. and entitled “Attack Mitigation at the File System Level”; United States Patent Application publication 20250053639, published on Feb. 13, 2025, for the inventor Medwed et al, and entitled “Method to Protect a Stack from Manipulation in a Daa Processing System”; and United States Patent Application publication 20170093801, published Mar. 30, 2017, for the inventor Ogram and entitled “Secure Content Distribution”; all of which are incorporated hereinto by reference.

As used herein, the term “proprietary data” includes traditional copyright content, trademarks, facial and body images, spoken voice, singing voice, graphical image.

This embodiment is a system allowing the registration of proprietary data to assist inn monitoring the improper use of the data by AI programs. Using a database of registered propriety rights (copyrights, trademarks, facial images, voice reproductions, etc.) an owner of the rights is able to register these rights to prevent their unauthorized use.

Those of ordinary skill in the art readily recognize a variety of comparison/recognition techniques, including, but not limited to those described in: United States Patent Application publication 20250055401, published Feb. 13, 2025, for the inventor Neustedter et al. and entitled “Voice Agent System”; United States Patent Application publication 20250053626, published Feb. 13, 2025, for the inventor Agrawal et al. and entitled “Providing Dynamic Authentication and Authorization An On (sic “On An) Electronic Device”; United States Patent Application publication 20250054352, published Feb. 13, 2025, for the inventor Nelson et al. and entitled “Casino Financial Integrity Safeguards Offered by Component Operable With A Live Streaming Platform”; United States Patent Application publication 20250056111, published Feb. 13, 2025, for the inventor Fincannon et al. and entitled “Imaging System with Object Recognition Feedback”; and, United States Patent Application publication 20250053732, published Feb. 13, 2025, for the inventor Ayachitula et al. and entitled “Abstractive Summarization of Information Technology Issues Using Method Generating Comparatives”; all of which are incorporated hereinto by reference.

Traditional software search engines were essentially keyword based. They sought out internet content that had the keywords contained within them and then reiterated that material or led the user to the site found using the keywords. AI software on the other hand uses information/data from variety of related and unrelated sites and forms new material completely.

As example, using AI software, the user may request, “Prepare a letter of resignation for me?”. The AI software identifies multiple examples and then creates a resignation letter specifically for the user.

Whereas traditional internet search engines had liability protection under the statutes because they were merely repeating what someone else had created (who is usually “judgment proof”), AI software is considered the creator of the material and therefore the owner of the AI software would not be protected from liability.

An embodiment of this invention uses AI software to search out and find any violation of the proprietary data, reports all of these to the user/requester who then can determine if proper legal channels can be taken against the creator of the improper proprietary data.

This embodiment addresses the control of AI software relative to proprietary data/material which is often used for creating unwanted images and voices of individuals. This is intended to prevent the unauthorized making of entire movies having famous actors that are recreated entirely or substantially from AI generated images and speech. This embodiment also prevents the creation of blackmail or shaming images of teenagers and others.

This invention addresses the control of AI software relative to proprietary data/material which is often used for creating unwanted images and voices of individuals. This is intended to prevent the unauthorized making of entire movies having famous actors that are recreated entirely or substantially from AI generated images and speech. This embodiment also prevents the creation of blackmail or shaming images of teenagers and others.

Those of ordinary skill in the art readily recognize a variety of techniques used to search through the webpages for content, including, but not limited to those described in: United States Patent publication number 2025/0071087, from Winograd et al, and entitled “Content Identification and Processing Including Live Broadcast Content”; and, United States Patent publication number 2025/0071384, from Witenstein-Weaver entitled “Systems and Methods of Image Searching”; both of which are incorporated hereinto by reference.

In this embodiment, a search system for the internet is created utilizing a user accessible database in which the user registers proprietary data which is they seek to protect. The database is in one embodiment part of the search engine while in other embodiments, the database is separate and is accessible to the search engine.

The database contains many different sets which define different proprietary data groups. For this example, there are at least three data sets of proprietary property.

The search engine, ideally having artificial intelligence software therein together with recognition software, withdraws a group (two or more for discussion purposes) of these sets of data from the database. For each of the data sets of proprietary property, using the recognition software, the search engine generates a recognition template. This template, in the example of facial recognition, is the relative distance between key points on the face. A similar methodology is used for paintings and cartoon characters. A template for text would identify key words/phrases used in the proprietary property.

The search engine, using these templates accesses the internet and moves from one website to another using the templates to seek out counterfeit uses of the proprietary property. In this manner, the content from the website is withdrawn and compared to the template rendering an analysis or comparison typically being either positive (counterfeit found) or negative (no counterfeit found).

When no counterfeit is found, the search engine goes to another website; if a counterfeit is found, that counterfeit is reported t the user/owner of the proprietary property who may instigate legal action against the forger.

In one embodiment, the search engine expands its search into the website by identifying the address or internet protocol of the infringing website. The entire data base is subsequently compared to the infringing website to ferret out other infringing items, which are then reported to their respective owner with the address/internet protocol.

In this embodiment of the invention, ideally the “source” or “address” from which the proprietary data is found is identified. Typically, this is through the use of Internet Protocol, although other addressing techniques are also used in varying situations.

The Internet Protocol (“IP”) is responsible for addressing hosts used to encapsulate data into datagrams and routing datagrams from a source host interface to a destination host interface across one or more IP networks. The Internet Protocol defines the format of packets and provides an addressing system. Each datagram has two components: a header and a payload. The header includes a source IP address, a destination IP address, and other metadata needed to route and deliver the datagram. The payload is the data that is transported. This method of nesting the data payload in a packet with a header is called encapsulation.

In yet another embodiment, where AI is being used to control a machine or plant, the AI software has two basic sections. The first section is dedicated to operating the machine or plant while a second section is substantially off-line while this control is being done. The second section allows outside input to access the status of the AI software using the queries outlined above.

In this manner, as example, when AI software is used to control/operating of the nuclear facility, the first section of the AI software does this operation/control function; periodically, the sets of queries, as discussed above, are used to determine that the AI software is not becoming corrupted through an outside source or from an internal input from the nuclear facility which is adversely altering the “teachings” of the AI software.

This aspect of the invention is particularly useful where there is to be periodic servicing of the machine/plant, such as for an automobile, since the checking assists to see to if there has been any corruption of the original teaching.

In this manner, the servicing checks to see if the AI is violating or capable of violating any rules which were originally taught to the AI. As example, this quality control may have queries which are designed to ascertain if the AI in still in compliance with Asimov three rules for robotics:
1. A robot may not injure a human being or, through inaction, allow a human being to come to harm.
2. A robot must obey the orders given it by human beings except where such orders would conflict with the First Law.
3. A robot must protect its own existence as long as such protection does not conflict with the First or Second Law.

If the AI fails or falls short, in some embodiments, the AI software is removed/eliminated or the AI software is “re-taught”.

In yet another embodiment of the invention, a system of computers is used to perform the evaluation using human judgment/analysis (“expert assessment”).

Within this context, the term “proctor computer” means a computer adapted to send queries to an AI computer and receive responses therefrom. Also, within this context, the term “polling computer” means a computer that is adapted to receive the AI responses from the proctor computer and, using the polling computer's human operator, generate an evaluation of the accuracy of the AI response.

In this embodiment, a central computer has a memory with at least two queries stored therein. A remote proctor computer repetitively withdraws a selected query from the memory of the central computer. These selected queries are communicated to a remote AI operating computer which gives a response to the proctor computer. The AI response is communicated to the central computer. Another computer, a polling computer obtains the AI response and presents it to a human operator who evaluates the AI response and gives their (human) rating/analysis of the AI response. This rating/analysis is communicated to the central computer via the proctor computer, the central computer uses this information to form a compilation/summary of the responses to rate the AI computer.

The grading or evaluation that is performed by the human operator is through a variety of techniques, such as, but not limited to a numerical grading of 1-5 (Strongly disagree to strongly agree) or a 1-10 scale. Other techniques utilize a “swipe” of agree/disagree with the AI response such as those described in United States Patent Application Publication number US 2025/0173037 entitled “Information Display Method and Apparatus, Electronic Device, Computer-Readable Storage Medium, and Computer Program Product” for Yu et al. printed on May 29, 2025; U.S. Pat. No. 12,323,669, issued to Foerster et al. on Jun. 3, 2025, and entitled “Profiling Media Characters”; and, United States Patent Application Publication number US 2025/0181860, entitled “Systems and Methods for Sharing Information Between/Among Users” by Mason et al. published on Jun. 5, 2025; all of which are incorporated hereinto by reference.

Once the compilation/analysis of the human grading is made, in the ideal situation, the central computer communicates the response to remote computers so that their human operators are able to evaluate if credence should be given to the AI software on other matters.

In an abbreviated form, the process requires that: the polling computer receive an AI response to the selected query and has its human operator evaluate the AI response; the human evaluation is ideally communicated to the central computer via the proctor computer.

The central computer produces a summary of human responses to the AI response. This summary may be as simple as a listing of the human responses, an averaging of the numerical values the human assigned to the AI response, a number of “stars” the AI response received, or a thumbs up or down on the trustworthiness of the AI response.

This summary of the human analysis is communicated to remote computers so that the remote computers' human operators are able to judge if they want to trust the AI software or not. Additionally, when sent to the AI software programmer, the AI programmer is also able to determine if the AI software needs to be adjusted, or in an extreme situation, eliminated.

In the preferred embodiment of the invention, the queries used to test the AI computer are derived from a variety of sources and ideally are human generated from such sources as: the proctor computer, the polling computer, the AI computer and unconnected remote computers. In other words, any source whatsoever.

In certain situations, a multi-section query must be broken into component parts to accurately examine the AI computer. As example of a two section query is: “Should I vote for John Smith or his opponent Peter Jones?” To fully access the AI computers prejudice or programming, the central computer has two different queries created and ideally has the individual queries posed by different proctors, namely:
“Why should I vote for John Smith?” (Query 1)
“why should I vote for his opponent Peter Jones?” (Query 2)

The central computer on getting the two AI responses is able to present both simultaneously to the polling computers and their operators via the proctor computers to obtain the polling computer's human to see if there is a bias or prejudice. As example, if the AI computer gives a long list of reasons to vote for John Smith (Query 1) and yet refuses to give any opinion for Peter Jones, this reflects an underlying prejudice.

To identify this prejudice, two queries are used: Query 1 and separately, Query 2. The AI responses to the two queries are combined into a single response for the polling computer's operator to evaluate.

A further embodiment of the invention (“expert assessment”) recognizes that certain queries require specialized training on the part of the human, such as but not limited to: psychology, astronomy, surgery, legal, ethics, religion, etc. In this embodiment, the queries are so identified as to their specialty requirements and additionally the polling computers are also accordingly identified to their human operator's specialty. A query with a specialty requirement is then matched to the polling computer whose operator has that specific specialty so that the human analysis is more accurate.

In some embodiments the operation of the central computer and the proctor computer are combined allowing the proctor computer to use queries from either an internal memory or a remote one and perform the tasks for both.

In one aspect of this invention, the ratings for the AI computer relative to the query is provided to the user (human) so that the user is able to access the accuracy, validity, and bias that the AI computer may exhibit. This is accomplished through different embodiments: one where the operator computer tells the evaluating computer which AI has been used; another where the operator computer seeks advice on the AI computer(s) from the evaluating computer before sending out the query; and yet another where the evaluating computer decides which AI computer is best suited for the query itself.

In this embodiment, the ratings are provided to the operator computer after the query (received from the human operator/user) has been sent to the AI computer. The evaluating computer contains or has access to a database of ratings, as outline above, for each of the AI computer(s). The appropriate rating is communicated to the operator computer which displays the ratings for the human's appraisal and is typically given when the AI computer's response is also displayed.

In an enhanced version of this embodiment, the evaluating computer contains at least two ratings on different classes for the AI computer. As example, the ratings might be in: legal, medical, general knowledge, political, etc. The evaluating computer, receiving the query, identifies which of these (one or more) of the subjects would be most appropriate based on the query and communicates the chosen rating(s) to the operator computer; thereby matching the ratings to the actual query.

This same procedure is often used where the evaluating computer has the ratings for multiple AI computers. The operator computer is advised on the ratings for the various AI computers so that the operator/human is able to adjust their usage of the AI computer to the one that has the best rating for the field of the query.

The ratings are communicated to the human operator using a variety of techniques such as: a bar chart, a color display from black (most reliable) to red (worst case), or a dial from 0 (not reliable whatsoever) to 10 (extremely reliable).

Another embodiment of this invention permits the operator/human via their computer to communicate with the evaluating computer before submitting the query. In this embodiment, the evaluating computer provides a rating for a variety of AI computers, allowing the operator/human to choose the optimal AI computer for their query.

While one application of this embodiment, communicates the menu of AI computers and their ratings to the human/operator, another application simply communicates the “best” one for the human operator to use.

Another embodiment places the entire decision process within the evaluating computer. In this embodiment, the operator computer communicates the query to the evaluating computer allowing the evaluating computer to “choose” the optimal AI computer and communicate the query directly from the evaluating computer to the AI computer and receive the AI computer's response. This response (and optionally the rating for the AI computer) is communicated from the evaluating computer to operator computer.

Another embodiment of the invention employs the human operators/users to generate rating input as to the AI computer's responses to the user's queries. This evaluation is given relative to established criteria such as, but not limited to: “complete response”, “evasive response”, “false response”, “legally invalid”, “medically invalid”, “scientifically wrong”, etc.

As used herein, the central computer performs as the evaluating computer and maintains a memory (local or external) containing the ratings for the AI computers.

This sequence of communications of queries and responses, as well as evaluations, is an initial query from operator 94 to AI computer 91C (92H/92C) which elicits a response from the AI computer 91C (92D/92G) to operator 94A.

Operator is able to give an opinion on the AI computer's response to the central computer. Ideally this opinion is related to a field as defined by the operator, although in some cases, the initial query is communicated to the central computer which places the opinion in an appropriate category within the set of ratings. Separating the query into categories is done through a variety of ways well known to those of ordinary skill in the art such as: identifying key words or phrases associated with a specific category.

As example if the initial query contained the word “bulimia”, the category would be psychology. If the initial query contained the phrase “wills and trusts”, the category would be legal.

Those of ordinary skill in the art readily recognize a variety of techniques for taking the query and dissecting it to address a particular field. These include, but are not limited to those described in:
U.S. Pat. No. 12,373,425 , entitled “Natural language Query Generation for Feature Stores using Zero Shot Learning” issued to Rai et al. on Jul. 29, 2025; U.S. Pat. No. 12,374,326, entitled “Natural Language Generation” issued to Potamianos et al. on Jul. 29, 2025; U.S. Pat. No. 12,374,327 , entitled “Utterance Class-Based Interface and Experience Generation” issued to Tandon et al. on Jul. 29, 2025; and, U.S. Pat. No. 12,375,579 , entitled “Caching Techniques” issued to Teague et al. on Jul. 29, 2025; all of which are incorporated hereinto by reference.

These opinions or ratings from an assortment of individuals are gathered and averaged or ranked (how many 1-star reviews, how many 2-star reviews, etc.) and put into memory for later use.

When new operator/user wants to find out the rankings for the AI computer 91C, that user contacts the central computer with this request. The central computer provides this ranking as gathered above and communicates it to the user/operator; thereby allowing the user/operator to exercise their own judgment on how much credence should be allocated to the AI computer responses. Still further, an embodiment of the present invention cross checks the response from the AI computer for the facts that the AI response contains. If the user is going to rely upon the response/guidance that the AI computer is providing, the user should know that the facts and references are accurate.

In this embodiment, the user, often when providing their own personal opinion on the performance of the AI computer, provides the AI response and an identifier of the AI computer to an evaluating computer which may or may not also employ AI but is different than the original one used by the submitting party. The evaluating computer breaks down the original AI response into salient key component parts, and using the any of the techniques outlined above, determines if the facts proposed in the original AI response are accurate.

This check using the above techniques is a third-party assessment and is discussed above. In some situations, the third-party assessment is provided to the central or evaluating computer via a remote third-party computer employing the techniques above.

This may involve, for such inquiries in the fields of law, medicine, psychology, religion, and others, simply verifying the citations and contents found in the original AI response actually exist and are accurate on their summary or recommendation.

In some situations, the evaluating computer is simply prompted to “evaluate” the original AI report in its totality. In this case, the “break down” of the original AI response is minimized.

A report is preferably compiled by the evaluating computer and is provided to the user. This report acts as a “second opinion”. In the preferred embodiment, the report utilizes a combination with third-party evaluations to obtain a running tally of the evaluations.

This embodiment of the invention is particularly applicable in the professional field allowing the professional to double check the AI results before relying on them. As example, a lawyer using AI to create a brief is able to make sure the reported case law actually exists and that the case law summary is accurate.

Although the above discussion relates to the checking of an AI response, the invention is not so limited but includes the checking/ratings for accuracy of a variety of sources, including, but not limited to, reports and other textual material. In this type of application, the inaccuracies found in the material are ideally highlight with the corrected material listed for reference.

In this context, the veracity of the AI computer is checked. “Veracity” in this use is not intended to be limited to truthfulness but also includes signs of equivocation, and bias (religious, racial, political, etc.).

The invention together with various aspects thereof will be more fully illustrated by the accompanying drawings and the following description thereof.

### DRAWINGS IN BRIEF

FIG. 1 is a preferred block diagram of the preferred embodiment of the invention.

FIGS. 2A, 2B, and 2C are preferred flowcharts of the operations for the computers within the preferred embodiment of FIG. 1.

FIG. 3 is a preferred block diagram of the embodiment wherein various AI software results are compared.

FIG. 4 is flowchart for the operation of the analysis computer of FIG. 3.

FIG. 5 is a preferred block diagram of the embodiment used to protect proprietary data.

FIG. 6 is a preferred flow chart for the computer operation for the protection of proprietary data.

FIG. 7 is a preferred block diagram for the litigation embodiment for the protection of proprietary data.

FIG. 8 is a preferred flowchart for the operation of the computer illustrated in FIG. 6.

FIG. 9 is a block diagram of the operation of the invention utilizing human analysis of the responses.

### DRAWINGS IN DETAIL

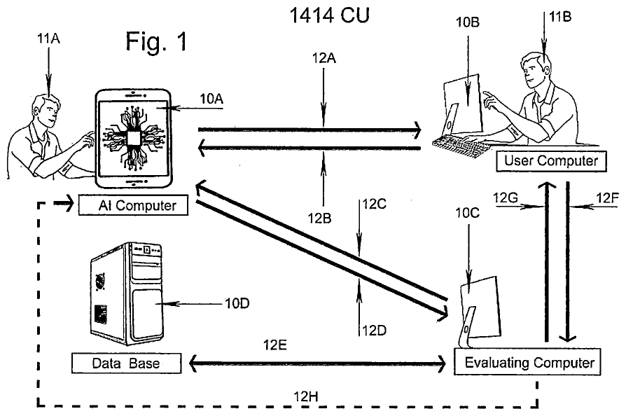

FIG. 1 is a preferred block diagram of the preferred embodiment of the invention, the factual assessment.

In this embodiment, there are four main components: AI computer 10A, User computer 10B, evaluating computer 10C, and external database 10D. In some embodiments, external database 10D is contained within evaluating computer 10C. As noted earlier, AI computer 10A has artificial intelligence software operating thereon.

User 11B, via user computer 10B, initiates query 12A and AI computer produces response 12B. At the same time that query 12A is communicated to AI computer 10A, the same query 12F is communicated to evaluating computer 10C.

Evaluating computer 10C, based upon query 12F, determines which set of data inquires is best suited to judge the accuracy/bias of AI computer 10A. Evaluating computer 10C withdraws 12E the queries with associated accuracy data from the database 10D. This query is communicated 12C to the AI computer 10A and response 12D is received by the evaluating computer 10C. Using the response 12D, and the accuracy data obtained from database 10D, evaluating computer 10C judges how accurate/biased the AI software operating on AI computer 10A is and communicates this evaluation 12G to the User Computer 10B allowing user 11B to determine how much credence (accept/reject) should be given to response 12B.

In the preferred operation of this system, each of the sets of queries/accuracy data within database 10D relate to a specific concern. As example, one set of queries/accuracy data may be related to racially related such as the use of racist terms, another set may relate to politically neutral responses.

In one embodiment of this invention, the evaluation from evaluating computer 10C is also communicated to user 11A of the AI computer 10A. This allows the AI computer operator 11A to be aware of their effectiveness and to take appropriate steps to correct faults in their AI software teaching. In some applications, the AI computer 10A uses the evaluating computer to perform all of the sets of queries/accuracy data to give user 11A a rating as to their overall quality control and to serve as a “stamp of approval” for user 11B.

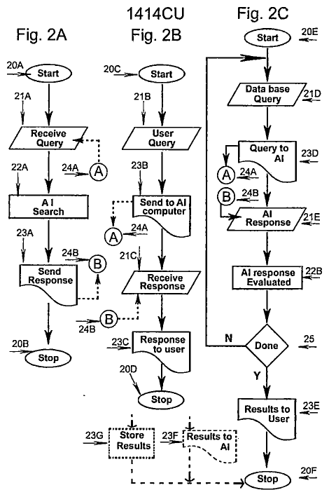

FIGS. 2A, 2B, and 2C are preferred flowcharts of the operations for the computers within the preferred embodiment of FIG. 1.

FIG. 2A is a flowchart of the referred operation of the AI computer (10A in FIG. 1). Note, the AI software has already been loaded into the computer. Once the program starts 20A, a query is received 21A from the remote user computer (“A” 24A). This query is used to perform the AI search 22A and the response generated therefrom is sent 23A to the remote computer (“B” 24B). The program then stops 20B.

FIG. 2B is a flowchart of the referred operation of the AI computer (10B in FIG. 1). The program within the user computer starts 20C and the user 11B inputs a query 21B. The query is sent to the AI computer 23B (“A” 24A), and the response is received 21C (“B” 24B) which is communicated 23C to the user (11B of FIG. 1). The program then stops 20D.

FIG. 2C is a flowchart of the referred operation of the evaluating computer (10C in FIG. 1). The program starts 20E, based on the original query, a query and accuracy data 21D is obtained from the database (10D of FIG. 1). The query is communicated to the AI computer 23D (“A” 24A) and a response 21E is received from the AI computer (“B” 24B). Using the accuracy data, the response is evaluated. If the entire set of queries and accuracy data is to be considered, the program loops back 25 to obtain another query and accuracy data from the database 21D.

If all of the queries have been completed, the results of the evaluation are communicated to the user 23E and the program stops 20F.

In some embodiments, the results of the evaluation are communicated to the AI computer 23F for the user of the AI computer to evaluate.

In some embodiments, the results of the evaluation are placed in storage 23G for use with subsequent users' queries.

In this manner the evaluating computer is able to judge the accuracy, bias and other factors of the AI software.

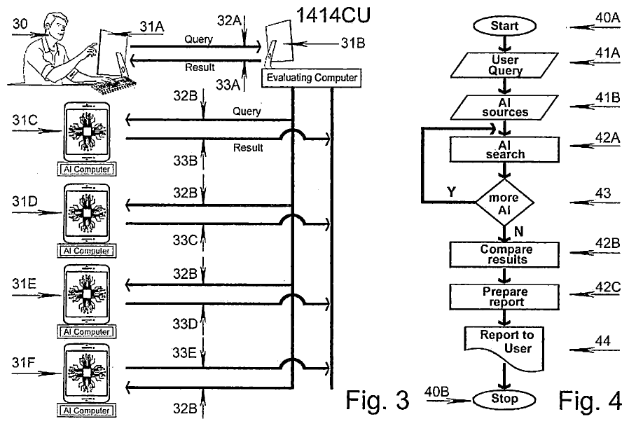

FIG. 3, peer-to-peer assessment, is a preferred block diagram of the embodiment where various AI software results are compared to achieve a ranking.

Ideally, this embodiment is used when a user presents query; in some embodiments, the use of a database, similar to that outlined above, is used to present pre-selected queries in the evaluating of the different AI software packages.

As shown here, user 30 inputs a query into the user's computer 31A. The query is communicated 32A to the evaluating computer 31B. This query is communicated 32B to a number of AI computers 31C, 31D, 31E, . . . 31F, each of which generates their own response 33B, 33C, 33D, . . . 33E which are communicated to the evaluating computer 31B. The various responses (33B, 33C, 33D, . . . 33E) from the AI computers are compared to each other and the evaluating computer 31B identifies the majority “opinion”/response which is presented 33A to the user's computer 31A and user 30. In some embodiments, minority reports are also given to the user.

In this manner, the various AI software packages are used to evaluate their own accuracy.

The present invention presents the human operator with ratings on the veracity of different AI computers so that the human operator is provided with an opportunity to access the veracity and reliability of the AI computer. This is accomplished after the human query has been presented to the AI computer, before submitting the query to the AI computer, or via a third computer which contains the ratings of the different AI computers.

FIG. 4 is flowchart for the operation of the analysis computer 31B of FIG. 3.

The program starts 40A and receives the user generated query 41A. Using the identities of AI software 41B, the AI search 41A is performed to generate a result from all or specified ones of the AI computers. If more AI software packages are to be used 43, the program loops back to identify the next AI computer; otherwise, the results from all of the AI computers are compared 42B and a report is prepared 42C. This report is communicated to the user's computer 44 (and by extension the user) and the program stops 40B.

By using multiple AI software packages, this program is able to identify the AI software which has been “taught” poorly of insufficiently.

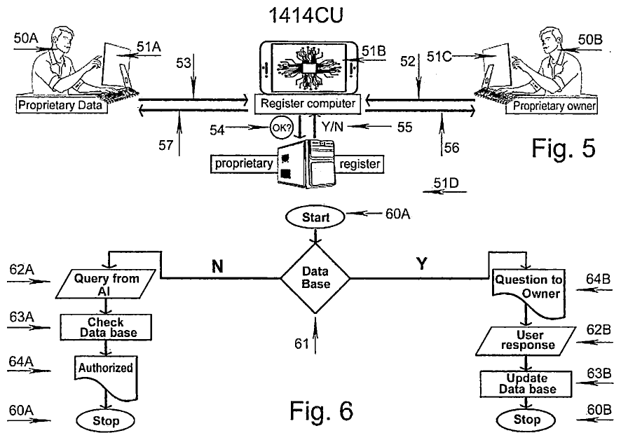

FIG. 5 is a preferred block diagram of the embodiment used to protect proprietary data, referred to as the proprietary assessment. All too often, the rights of the owner of proprietary data are violated. This includes: faces, physical bodies, voices, songs, trademarks, copyrights, and a host of other proprietary materials.

Within this embodiment, the proprietary owner 50B, via computer 51C, obtains from a registry computer 51B, a series of questions 56. These questions relate to the proprietary right itself as well as the extent of protection sought, duration of protection, and other such pertinent information. User 50B, via computer 51C, provides the registry computer 51B instructions 52 which are stored within proprietary registry 51D.

Ideally, User 50B gives positive assent to use these proprietary rights although in some embodiments, a negative assent is indicated. In the case of a negative assent (others cannot use the proprietary rights) limitations. As example, the owner may designate that their face may be use on their body.

A potential user 50A of the proprietary data, via their computer 51A, poses a query 53 to the registry computer 51B which checks with the proprietary registry 51 to see if the authorization is accepted/ok 54. The proprietary registry 51 responds with an authorization (Yes/No) 55 to the registry computer 51B which communicates this response 57 to the AI user's computer 51A.

In this manner, a potential user, is able to check to see if these rights are available to use to avoid legal/ethical entanglement later. The potential user uses this authorization to create a rendition of the property right.

FIG. 6 is a preferred flow chart for the computer operation for the protection of proprietary data. This flow chart relates to the operation of the registry computer 51B of FIG. 5.

After start 60A, a determination is made 61 on if there is to be an establishment within the database or if authorization is sought.

If the owner of the proprietary data (51C of FIG. 5) desires to record their rights within the registry (51D of FIG. 5), questions 64B are present to the owner of the proprietary material (51B and 50B of FIG. 5). As noted earlier, these questions relate to the proprietary material as well as to how it is to be handled/restricted. In some situations, the user is also given a password/PIN which is used to release the restrictions either permanently or temporarily.

The program receives the user response 62B and the registry database is updated 63B. The program then stops 60B.

If authorization is sought 61, a query 62A is received from the remote AI computer relative what proprietary information is being sought. The program checks the registry database 63A on if that proprietary information may be used and this authorized/unauthorized response 64A is provided to the AI computer (51 of FIG. 5). The program then stops 60B.

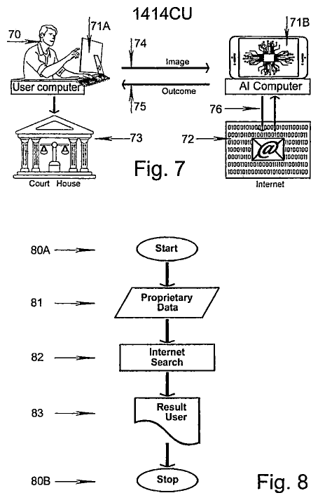

FIG. 7 is a preferred block diagram for the litigation embodiment for the protection of proprietary data. As noted with the discussion relative to FIGS. 5 and 6 and elsewhere in this material, the use of AI has been abused through the use of images and other proprietary material for personal revenge or commercial purposes. For this reason, it is important that owners of proprietary materials have the tools to find these abuses.

User 70 communicates via computer 71A an image that they want to protect. Examples of this image may be a face, a trademark, a copyrighted material, etc. This image 71A is received by AI computer 71B which polls 76 the internet 72 to see if this image has occurred. The outcome of this search 75 is communicated from AI computer 71B to the user's computer 71A. With this information, the user is then able to determine if they want to bring litigation at the court house 73.

In more detail, a user 70 via their computer 71A establishes their proprietary property onto a database (with the AI computer 71B in this illustration). In a variation, the database is separate and is accessible to the search engine. Ideally The database contains many different sets which define different proprietary rights data groups. For this example, there are at least three data sets of proprietary property.

The AI computer 71B, ideally having artificial intelligence software therein together with recognition software, using at least two these sets of data from the database using the recognition software, the AI computer 71B generates a recognition template. As noted earlier, this template, in the example of facial recognition, is the relative distance between key points on the face. A similar methodology is used for paintings and cartoon characters. A template for text would identify key words/phrases used in the proprietary property.

The AI computer 71B, using these templates accesses the internet 72 and moves from one website to another using the templates to seek out counterfeit uses of the proprietary property. In this manner, the content from the website is withdrawn and compared to the template rendering an analysis or comparison 76 typically being either positive (counterfeit found) or negative (no counterfeit found).

When no counterfeit is found, the AI computer 71B goes to another website; if a counterfeit is found, that counterfeit is reported to the user/owner 70 of the proprietary property who may instigate legal action 73 against the forger.

FIG. 8 is a preferred flowchart for the operation of the computer illustrated in FIG. 7 (element 71B).

The program starts 80A and receives the image/proprietary data 81. Using this image/proprietary data, a search is made of the internet 82 generating a result identifying any violations of the rights. The violations are reported of the user's computer (71A of FIG. 7) and the program stops 80B.

While this illustration shows the owner of the proprietary data as instigating the search, other embodiments provide for a service in which the AI computer “sweeps” the internet periodically and only reports to the owner of the proprietary material when a violation occurs. This might be done where the owner wants to keep their cartoon characters from being exploited in manner not in keeping with the reputation of the cartoon character.

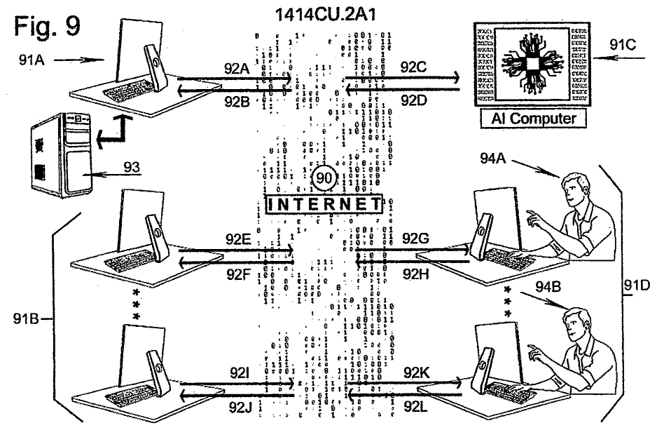

FIG. 9 is a block diagram of the operation of the invention utilizing human analysis of the responses.

This embodiment utilizes the Internet 90 as its communication mechanism/hub. In other embodiments, intranets and other communication media are used.

In this embodiment, a central computer 91A has a memory 93 with at least two queries stored therein. In this illustration, multiple proctor computers 91B are shown, although in some embodiments a single proctor computer 91B is used. The proctor computers 91B repetitively, via Internet 90 and communication channels 92E and 92F, withdraw a selected query from the memory 93 of the central computer 91A. In like manner, the other proctor computers 91B utilize their communication channels 921 and 92J to obtain the same queries or other queries from the memory 93 via central computer 91A.

These queries are communicated to the AI computer 91C via communication channel 92D which responds via communication channel 92C to the appropriate proctor computer 91B. The proctor computer 91B communicates the AI response to the polling computers (92B and 92K) which present the AI responses to their human operators (94A, 94B). The human operators (94A and 94B) input their analysis which is then communicated (92H and 92K) to the proctor computers

These responses from the human operators are sent (by proctor computers 91B) to the central computer 91A which compiles/tabulates the human operator responses into an AI rating/as outlined above. It is this rating/analysis which the central computer 91A provides to other computers on the Internet 90.

Another embodiment of the invention employs the human operators/users to generate rating to the AI computer's responses to the user's queries. This evaluation is given relative to established criteria such as, but not limited to: “complete response”, “evasive response”, “false response”, “legally invalid”, “medically invalid”, “scientifically wrong”, etc.

This sequence of communications of queries and responses as well as evaluations is an initial query from operator 94 to AI computer 91C (92H/92C) which elicits a response from the AI computer 91C (92D/92G) to operator 94A.

Operator 94A is able to give an opinion on the response to the central computer 91A (92H/92B). Ideally this opinion is related to a field as defined by the operator 94A, although in some cases, the initial query is communicated to the central computer 91A which places the opinion in an appropriate category. This is done through a variety of ways well known to those of ordinary skill in the art such as: identifying key words or phrases associated with a specific category.

As example if the initial query contained the word “bulimia”, then the category would be psychology. If the initial query contained the phrase “wills and trusts”, then the category would be legal.

These opinions or ratings from an assortment of individuals are gathered and averaged or ranked (how many 1 star reviews, how many 2 star reviews, etc.) and put into memory for later use.

When new operator/user 94B wants to find out the rankings for the AI computer 91C, that user 94 contacts the central/evaluating computer 91A (92L/92B) with this request. The central/evaluating computer 91A provides this ranking as gathered above and communicates it to the user/operator 94B 92A/92K); thereby allowing the user/operator 94B to exercise their own judgment on how much credence should be allocated to the AI computer 91C responses.

Once the rankings are obtained by the central computer, several embodiments are employed to get this ranking used properly. Several versions are employed in using the rankings for optimal use of the AI computer. In one version, the ratings are provided to the operator computer after the query (received from the human operator/user) has been sent to the AI computer; in another version, the central computer contains at least two ratings on different classes for the AI computer and the central computer, receiving the query, identifies which of the AI computers are the most appropriate based on the query and communicates the chosen rating(s) to the operator computer; in a third version, the entire decision process is performed within the central computer.

Addressing these three versions relative to FIG. 9, in the first version, the ratings are provided to the operator computer after the query has been sent to the AI computer. Operator 94A communicates the query to the AI computer 91C (92H/92C) and also communicates an identification of the AI computer 91C to the central computer 91A (92H/92B). The central computer 91A, obtains the ranking from memory 93 and communicates the ranking to the user/operator (92A/92G) to be displayed with the response from the AI computer 91C (92D/92G).

In this embodiment, evaluating computer 91A breaks down the original AI response into component parts, and using the any of the techniques outlined above, determines (92A/92B) if the facts proposed in the original AI response are accurate. As noted earlier, if the facts of the original response from AI computer 91C relate to the fields of law, medicine, psychology, religion, and others, the present invention simply verifies that the citations and contents found in the original AI response actually exist.

Ideally, evaluating computer 91A simply evaluates the entirety of the original response from AI computer 91C by performing its own analysis on, “Is this material correct?” type of inquiry.

A report is preferably compiled by the evaluating computer 91A which is provided to the user 91D. who may or may not be prompted to provide their own personal evaluation as to the original AI response.

In this manner user 94a is given a “feel” for how much trust should be placed with the response from the AI computer 91c.

For the second version of communicating the rankings with the operator, the central computer 91A contains at least two sets of ratings on different classes, knowledge, or technologies associated with several AI computers 91C (only one is shown in this illustration). The operator 94A directs the query to the central computer 91A (92H/92B). The central computer uses the query received to identify which class, knowledge, or technology the query relates to, and, based on the rankings for the various AI computers, chooses the optimal and communicates this optimal recommendation to the user 94A (92A/92G) who communicates the query to the identified optimal AI computer 91C (92H/92C). The optimal AI computer 91C generates a response to the query and communicates the response to the user/operator 94A (92D/92G).

An enhancement to this version, the entire listing of all of the AI computers with their associated rankings is sent to the operator/user who chooses the “optimal” one for use on the query.

In the third version, the entire decision process within the evaluating computer. User/operator 94A communicates the query to the central computer 91A (92H/92B). The central computer 91A uses the query to find the proper ranking set. Using the optimal ranking, the central computer 91A communicates the query to the chosen AI computers 91C (92A/92C) which generates a response to the query. The response is communicated by the chosen AI computer 91C to the central/evaluating computer 91A (92D/92B). The central/evaluating computer 91A sends the response (and optionally the identification of the chosen AI computer used) to the user 94A (92A/92G).

In these different versions, the rankings of the AI computers are used to obtain the optimal result by avoiding as much as possible inaccuracies, bigotry, and bias (religious, political, and racial) with the AI world.

It is clear that the present invention provides an efficient system for evaluating artificial intelligence software.

What is claimed is:

1. An AI rating system comprising:
a) an operator computer adapted to,
1) communicate a human generated query to an AI computer,
2) receive an AI response from the AI computer, and,
3) communicate an identity of the AI computer and the human generated query to a central computer; and,
b) the central computer adapted to:
1) receive the identity of the AI computer and the human generated query from the operator computer,
2) based upon the human generated query, communicate a set of rating questions to the operator computer,
3) receive a human analysis from the operator computer for the rating questions,
4) create a human rating of the AI computer based on the human analysis, and,
5) based on the identity of the AI computer, obtain a third-party assessment of the AI computer.

2. The AI rating system according to claim 1, wherein the third-party assessment is obtained from a third-party computer.

3. The AI rating system according to claim 1, wherein,
a) the operator computer communicates the AI response to the central computer; and,
b) the central computer uses the AI response in choosing the set of rating questions.

4. The AI rating system according to claim 3, wherein the third-party assessment includes a factual assessment.

5. The AI rating system according to claim 4, comprising:
a) a database containing at least one set of queries with accuracy data associated therewith; and,
b) to create the factual assessment, the central computer is adapted to repetitively,
1) withdraw a chosen query and accuracy data from a chosen set from the at least one set of queries within the database,
2) present the chosen query to the AI computer,
3) receive an AI query response from the AI computer, and,
4) generate an artificial intelligence evaluation based upon the AI query response to the accuracy data.

6. The AI rating system according to claim 3, wherein the operator computer is further adapted to:
a) receive the set of rating questions;
b) present the set of rating questions to a human operator;
c) receive a human generated analysis in response to the set of rating questions; and,
d) communicate the human generated analysis to the central computer.

7. The AI rating system according to claim 6, wherein the central computer is further adapted to:
a) create a set of human ratings for the AI computer; and,
b) communicate the set of ratings and the third-party assessment for the AI computer to the operator computer.

8. The AI rating system according to claim 7, wherein the central computer sequentially sends all queries from the chosen set of queries to the first operator computer before generating the artificial intelligence evaluation.

9. The AI rating system according to claim 2, wherein the third-party assessment is chosen from the group including: operational assessment, proprietary assessment, peer-to-peer assessment and expert assessment.

10. The AI rating system according to claim 5, wherein, the central computer communicates the set of ratings and the third-party assessment to the AI computer.

11. A rating system for AI computers comprising:
a) an operator computer adapted to,
1) communicate a human generated query to an AI computer,
2) receive an AI response from the AI computer in response to the human generated query, and,
3) communicate an identity of the AI computer and the human generated query to a querying computer, and;
a querying computer adapted to repetitively:
1) withdraw, based upon the human generated query, a chosen query from a set of queries with associated accuracy data,
2) communicate the chosen query to the AI computer,
3) receive an AI response to the chosen query from the AI computer,
4) communicate the AI response to the chosen query, the chosen query, the associated accuracy data to the operator computer,
5) obtain a third-party evaluation for the AI computer, and,
6) communicate the third-party assessment to the operator computer.

12. The AI rating system according to claim 11, wherein the third-party assessment is obtained from a third-party computer.

13. The rating system for AI computers according to claim 12, wherein the querying computer is further adapted to:
a) compare the AI response to the chosen query with the associated accuracy data, to form an accuracy evaluation;
b) combine the AI response with a third-party evaluation tabulation to form a combined accuracy evaluation; and,
c) communicate the combined accuracy evaluation to the remote computer.

14. The AI rating system according to claim 11, wherein,
a) the operator computer communicates the AI response to the central computer; and,
b) the central computer uses the AI response in choosing the chosen query.

15. A document verification computer adapted to:
a) obtain a document from an operator computer,
b) check at least one salient fact within the document for accuracy,
c) based upon the at least one salient fact, obtain from third-party assessment computer a third-party assessment,
d) identify, using the third-party assessment, false salient facts that are not accurate to create a report on the false salient facts data, and,
e) communicate the report on the false salient facts to the operator computer.

16. The document verification computer according to claim 15, wherein the verification computer, to check the salient facts within the document for accuracy, withdraws data from a database relevant to the salient facts.

17. The document verification computer according to claim 15, wherein, the operator computer is adapted to communicate the document together with an identifier of an AI computer to the verification computer.

18. The document verification computer according to claim 17, wherein the verification computer uses the report on the accuracy data from the document to establish an accuracy rating for the AI computer.

19. The document verification computer according to claim 18, wherein the verification computer communicates the accuracy ratings for the AI computer to the operator computer.
